(19) United States
(12) Patent Application Publication
(10) Pub. No.: US 2010/0156236 A1
(43) Pub. Date: Jun. 24, 2010

(54) ROLLER BRUSHES FOR ELECTRICAL MACHINERY,

(75) Inventors: John Charles Ziegert, Seneca, SC (US); Wallace Gregory Sawyer, Gainesville, FL (US); Pamela Dickrell, Gainesville, FL (US); Jason Bares, Philadelphia, PA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: University of Florida Research Foundation, Inc., Gainesville, FL (US)

(21) Appl. No.: 12/439,342

(22) PCT Filed: Aug. 29, 2007
(86) PCT No.: PCT/US07/18913

§ 371 Date: Nov. 13, 2009

Related U.S. Application Data
(60) Provisional application No. 60/841,183, filed on Aug. 29, 2006.

(51) Int. Cl. H01R 39/28

(52) U.S. Cl. 310/238

(57) ABSTRACT

Various embodiments provide a rotating electrical machine (10) that includes an electrical supply coupled to a stator (13), a rotor (12), and a plurality of roller elements (or brushes) (15) for transferring electrical current from the stator (13) to the rotor (12). In one embodiment, each roller element (15) is compressed between the rotor (12) and the stator (13) so that outward forces resulting from expansive properties of each roller element (15) urge the roller element (15) into contact and maintain the roller element (15) in contact with the rotor (12) and the stator (13). For example, in one embodiment, each roller element (105) has a hollow, substantially cylindrical body formed of a conductive material that is elastically biased in a radially outward direction to maintain contact with the rotor (12) and the stator (13).

### BACKGROUND OF THE INVENTION

Many types of rotating electrical machinery (e.g., motors and generators) require a means of transferring electrical current from an electrical supply to a rotor. In most cases, the operation of the machine is dependent on the existence of multiple poles on the rotor that must be energized in phase with the rotational position of the rotor. The energizing is normally accomplished through the use of “brushes” that slide on a surface of the rotor and sequentially contact individual poles. Brushes are often made from graphite, despite graphite's relatively poor electrical conductivity, and must be replaced at regular intervals as they wear out.

Homopolar motors do not have multiple poles on the rotor. Therefore, the brushes are energized with the same voltage. As a result, sliding brushes are not necessary for transferring the current to the rotor. The current can also be transferred using conductive rollers, which are similar to ball or roller bearings. However, when current is passed through ball bearings or other roller elements, their life span may be greatly shortened as a result of arc-induced erosion. Arc-induced erosion occurs when individual roller elements lose contact with the rotor or stator and small sparks or arcs occur. Over time, the sparks cause damage to the surfaces of the roller elements, and this damage leads to premature failure of the roller elements.

The contact loss may be avoided if the roller elements were geometrically perfect. However, due to manufacturing tolerances, roller elements cannot be manufactured this way. In addition, because the individual roller elements typically have high stiffness, very large loads are required to bring the roller elements into contact simultaneously, and these large loads cause damage to the roller elements and shorten their life span.

Therefore, there is a need for improved systems and methods for transferring electrical current to a rotor. More specifically, there is a need for systems and methods for preventing the loss of contact of roller elements that leads to arcing.

### BRIEF SUMMARY OF THE INVENTION

Various embodiments of the invention provide a rotating electrical machine that includes an electrical supply coupled to a stator, a rotor, and a plurality of brushes adapted for transferring electrical current from the stator to the rotor. Each brush is compressed between the rotor and the stator so that outward forces resulting from expansive properties of each particular brush urge at least a portion of the brush into contact with both the rotor and the stator and maintain the brush in contact with both the rotor and the stator. In a particular embodiment, each brush has a hollow, substantially cylindrical body formed of a conductive material and is elastically deformable in a radial direction to provide at least a portion of the outward forces.

In another embodiment, a rotating electrical machine is provided that includes an electrical supply coupled to a stator, a rotor, and a plurality of brushes adapted for transferring electrical current from the stator to the rotor. Each brush has a shaft having a first end and a second end, a first tapered roller that is mounted adjacent a first end of the shaft, a second tapered roller mounted adjacent a second end of the shaft, and at least one biasing assembly that is adapted to urge at least a portion of the first tapered roller and at least a portion of the second tapered roller into contact with the rotor and stator and maintain the first tapered roller and the second tapered roller in contact with the rotor and stator. In one embodiment, the biasing assembly includes two compression springs that are each disposed within a recessed portion define in each tapered roller.

In another embodiment of the invention, a rotating electrical machine is provided that includes an electrical supply coupled to a stator, a rotor, and a plurality of brushes adapted for transferring electrical current from the stator to the rotor. Each brush includes (1) at least two disk sections that are spaced apart from each other along a central axis extending through the disk sections and (2) at least one flexible element positioned between two of the disk sections. The flexible element is adapted for urging at least a portion of each of the disk sections into contact with the rotor and the stator and maintaining contact of the disk sections with the rotor and the stator.

In various other embodiments, a method of transferring electrical current to a rotor of a rotating electrical machine is provided. The method includes the steps of: (1) providing a stator and a rotor; (2) providing a plurality of roller elements that are adapted for transferring electrical current from the stator to the rotor; (3) compressing the plurality of roller elements; and (4) while the plurality of roller elements are compressed, inserting the plurality of roller elements intermediate the rotor and the stator. The roller elements have a reduced radial stiffness and are biased against a surface of the stator and a surface of the rotor. According to one embodiment, the step of compressing the roller elements includes the steps of (1) providing a plurality of substantially cylindrical bodies; and (2) compressing the substantially cylindrical bodies intermediate the stator and the rotor so that outward forces resulting from expansive properties of each particular substantially cylindrical body (A) urge the particular substantially cylindrical body into contact with the rotor and the stator; and (B) maintain the particular substantially cylindrical body in contact with the rotor and the stator.

### BRIEF DESCRIPTION OF THE DRAWINGS

Having thus described the invention in general terms, reference will now be made to the accompanying drawings, which are not necessarily drawn to scale, and wherein:

FIG. 1 depicts a perspective view of, a roller element testing rig that includes a plurality of roller elements according to a particular embodiment of the invention. The testing rig includes a stator and a rotor (much like a motor), and is used to demonstrate how roller elements according to various embodiments of the invention would be used within the context of rotating electrical machinery, such as a motor or generator.

FIG. 2 depicts a perspective view of a roller element according to a particular embodiment of the invention.

FIG. 3 depicts a perspective view of a roller element according to another embodiment of the invention.

FIG. 4 depicts a perspective view of a roller element according to yet another embodiment of the invention.

FIG. 5 depicts an end view of the roller element testing rig of FIG. 1.

FIG. 6 depicts a cross-sectional view of a rotor, stator, and two roller elements according to a particular embodiment of the invention. An additional roller element is shown in from non-cross-sectional perspective.

FIG. 7 depicts a cross-sectional view of a rotor, stator, and roller element according to a further embodiment of the invention.

FIG. 8 is a perspective view of the roller element of FIG. 7.

### DETAILED DESCRIPTION OF VARIOUS EMBODIMENTS OF THE INVENTION

The present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

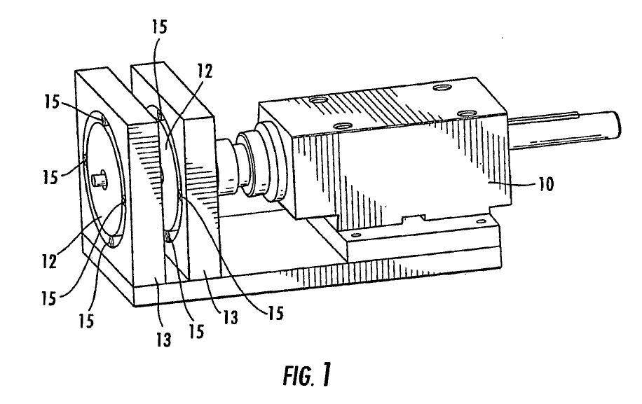

According to various embodiments of the invention, as shown in FIG. 1, a rotating electrical machine 10 (e.g., a motor or generator) is provided that includes at least one pair of a rotor 12 and a stator 13. The stator 13 receives electrical current from an electrical source and transfers the current to conductive roller elements 15 positioned between the rotor 12 and the stator 13. The conductive roller elements 15 transfer the current to the rotor 12, which results in the rotation of the rotor 12. Although the rotor 12 in the embodiment shown in FIG. 1 is positioned internal to an inner surface of the stator 13, the stator 13 may be positioned internal to an inner surface of the rotor 12 in various other embodiments, which are not shown.

Various embodiments of the invention include roller elements 15 that are adapted to transfer large electrical currents (e.g., about 54,000 amperes). In certain embodiments, the roller elements 15 have a longer life span (e.g., about 5 years) than conventional roller elements because they are adapted to prevent the loss of contact that leads to arcing. According to various embodiments, this goal is accomplished by manufacturing individual roller elements that are biased (e.g., through properties and/or mechanical features of the roller elements themselves) into maintaining contact with the rotor 12 and the stator 13. For example, various embodiments of the roller elements 15 are manufactured to have a contact stiffness that allows the roller elements 15 to substantially maintain contact with the rotor 12 and the stator 13 when the roller elements 15 are in a compressed state between the rotor 12 and stator 13.

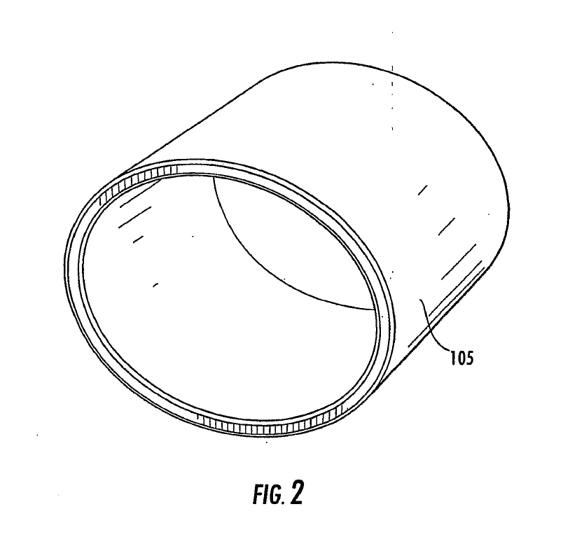

In particular, in various embodiments, each roller element is manufactured to have a relatively low radial stiffness such that deflections on the order of a few tenths of a millimeter do not cause significant changes in the contact force, e.g., in the range of 10 to 20 N/mm. In particular, according to the embodiment shown in FIG. 2, each roller element 105 is a thin walled cylindrical shell that comprises (and in various embodiments consists of, or consists essentially of) a relatively high conductivity material (e.g., copper or silver). Each roller element 105 is radially compressed during assembly of the rotating electrical machine 10 such that the roller elements 105 are elastically biased against the rotor 12 and stator 13, which prevents the roller elements 105 from losing contact with the rotor 12 and stator 13 during operation of the rotating electrical machine 10 and from experiencing excessive contact forces that may result from irregularities in the gap between the rotor 12 and the stator 13. For example, each roller element 105 may be radially compressed before (and/or while) being inserted between the stator 13 and rotor 12, or each roller element 105 may be radially compressed after being positioned adjacent the stator 13 or rotor 12 such that the roller elements 105 are in a compressed state when the stator 13 and rotor 12 are assembled adjacent each other.

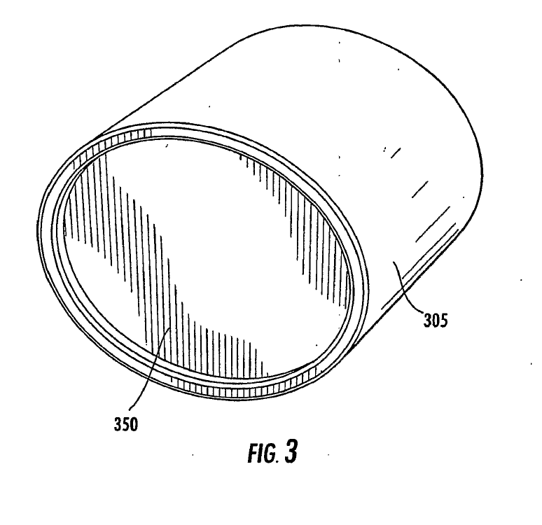

In a particular embodiment, which is shown in FIG. 3, an appropriate amount of elastomeric material 350 (such as urethane, silicone rubber, Viton, or other highly compressible material) is filled into one or more roller elements 315 to tailor the stiffness.

In regard to one particular embodiment, preliminary tests have been conducted using roller elements described above in a reciprocating tribometer carrying current densities well in excess of the Navy requirements. After 200,000 reciprocation cycles and over 25,000 meters of relative travel, the roller elements showed minimal wear and degradation.

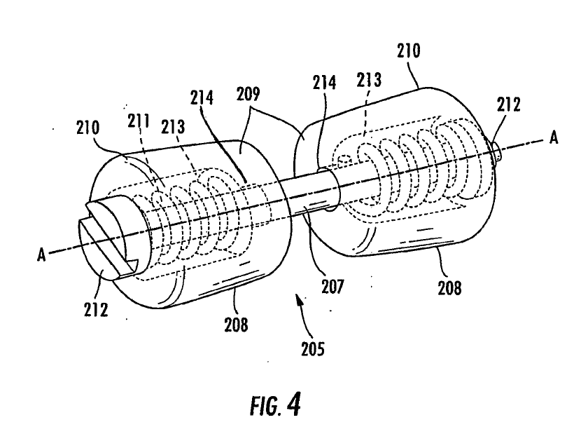

According to another embodiment, such as the embodiment shown in FIG. 4, each roller element 205 comprises a pair of tapered rollers 208 that are coupled by a shaft 207 and that are axially biased relative to each other. Each roller 208 has a substantially circular cross section that varies in radius along the length of the roller and that tapers (e.g., in a substantially linear fashion) in a radially inward direction from a first end 210 to a second end 209 of the roller 208 along an axis of rotation of the roller 208. In the particular embodiment shown in FIG. 4, each roller 208 further defines a substantially cylindrical aperture 214 that extends along the rotational axis of the roller 208 from the first end 210 to the second end 209. In various embodiments, the aperture 214 is dimensioned to receive at least a portion of the shaft 207 such that the rotational axis of the roller 208 is coaxial with a central axis A-A of the shaft 207. In addition, each roller 208 defines a substantially cylindrical recessed portion 213 that extends axially inwardly from the first end 210 of the roller 208 toward the second end 209 and defines an inner circumferential wall that is substantially perpendicular to the central axis of the roller 208. In various embodiments, the radius of the recessed portion 213 is larger than the recess of the aperture 214, and the recessed portion 213 is adapted for receiving the end of the shaft 207 and a compression spring 211 that is positioned coaxially around the shaft 207. One end of the compression spring 211 is disposed adjacent the substantially perpendicular wall.

In various embodiments, the shaft 207 defines a head end and a foot end that is threaded so that a stop, such as a nut can be threaded onto the foot end of the shaft 207.

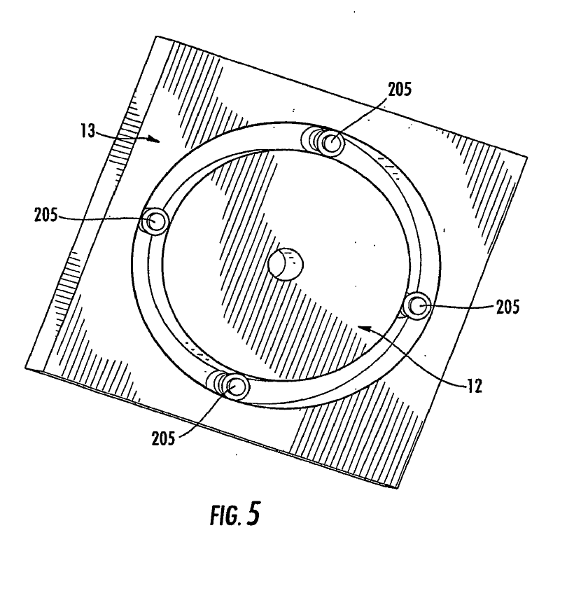

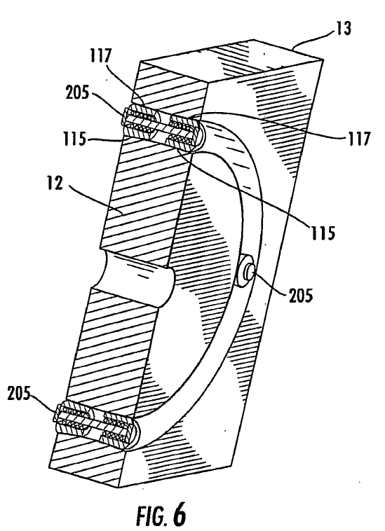

To assemble the tapered rollers 205 between the stator 13 and rotor 12 according to the embodiment shown in FIGS. 5 and 6, a first compression spring 211 is threaded onto the shaft 207 and positioned adjacent the head end of the shaft 207. A first roller 208 is then positioned onto the shaft 207 adjacent the shaft's head end so that the first compression spring 211 is positioned within the recessed portion 213 of the first roller 208. The foot end of the shaft 207 is then placed through the gap between the stator 13 and the rotor 12 so that the first roller 208 is positioned adjacent a first edge of the stator 13 and the rotor 12. Next, a second roller 208 is positioned onto the shaft 207 adjacent the shaft's foot end, and a second compression spring 211 is threaded onto the shaft 207 and positioned within the recessed portion 213 of the second roller 208 (see FIG. 4). A nut is then threaded onto the foot end of the shaft 207 to prevent movement of the rollers 208 relative to the ends of the shaft 207 and to compress the compression springs 211 within the recessed portions 213 of each roller 208. As the rotor 12 turns and the rollers 208 travel around the periphery of the rotor 12, in various embodiments, any variations in gap between the rotor 12 and stator 13 are accommodated by the spring-loaded axial translation of the rollers 208 relative to each other, thus preventing loss of contact and arcing. Furthermore, in one embodiment, the first ends 210 of the rollers 208 have a large radius crown to reduce contact stresses and allow rolling around the periphery of the rotor 12. In an alternative embodiment (not shown), an elastomeric material may be used instead of or in addition to the compression springs 211 to bias the rollers 208 against the rotor 12 and stator 13.

In a further embodiment, as shown in FIG. 6, the rotor 12 and stator 13 each define opposing double-tapered surfaces 115, 117. In particular, the double-tapered surface 115 of the rotor 12 tapers (e.g., along a substantially linear slope) from the respective outer lateral edges of the rotor's contact surface to the center of the rotor's contact surface. Similarly, in this embodiment, the double tapered contact surface 117 of the stator 13 tapers (e.g., along a substantially linear slope) from the respective outer lateral edges of the stator's contact surface to the center of the stator's contact surface. In a particular embodiment, the taper angle of the double-tapered surfaces 115, 117 is substantially similar to the taper angle of the rollers 208, which results in an increased contact surface area between each roller 208 and the respective contact surfaces of the rotor 12 and stator 13.

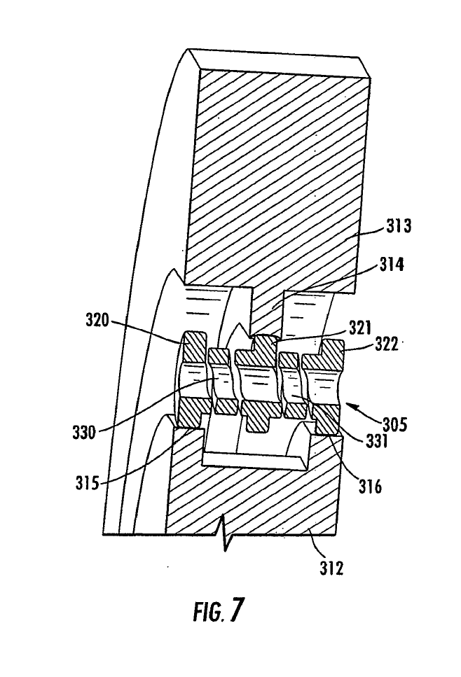

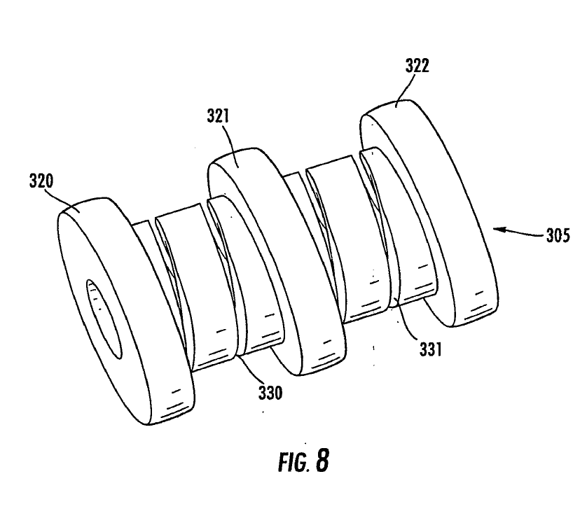

In yet another embodiment, shown in FIGS. 7 and 8, the roller brush 305 includes three disk sections 320-322 that are spaced apart from each other along the length of a central axis. The disk sections 320-322 are preferably each positioned so that the central axis extends through the center of each disk section 320-322. As shown in FIG. 8, in a particular embodiment, an inner side of the first disk section 320 is connected to a first side of the second disk section 321 via a first flexible element (e.g., a first helical spring member 330), and a second side of the second disk section 321 is connected to an inner side of the third disk section 322 via a second flexible element (e.g., a second helical spring member 331). In various embodiments, the first, second, and third disk sections 320-322 and the first and second flexible elements 330, 331 are positioned coaxially along a common central axis.

In the embodiment shown in FIG. 7, the rotor 312 may be provided with a first track 315 that extends outwardly toward the stator 313 adjacent a first face of the rotor 312, and a second track 316 that extends outwardly toward the stator 313 adjacent a second face of the rotor 312. In particular embodiments, the first and second tracks 315, 316 extend around (or at least substantially around) the circumference of the rotor 312. In various embodiments, the first track 315 is adapted to engage the first disk section 320 of the roller brush 305 when the roller brush 305 is in use. Similarly, the second track 316 is adapted to engage the third disk section 322 of the roller brush 305 when the roller brush 305 is in use.

In this embodiment, the stator 313 may be provided with a central track 314 that extends outwardly toward the rotor 312 between the first and second tracks 315, 316 referenced above. In various embodiments, the central track 314 is adapted to engage the second disk section 321 of the roller brush 305 when the roller brush 305 is in use.

In a particular embodiment, the diameters of the central, first, and second tracks 314, 315, 316 referenced above are selected so that when the roller brush 305 is in use, the roller brush's second disk section 321 is biased slightly toward the rotor 312 and the first and third disk sections 320 and 322 are biased slightly toward the stator 313. This arrangement causes the first and second flexible elements 330, 331 to flex and create a low-stiffness contact force between the roller brush 305 and both the rotor 312 and the stator 313.

### CONCLUSION

Many modifications and other embodiments of the invention will come to mind to one skilled in the art to which this invention pertains having the benefit of the teachings presented in the foregoing descriptions and the associated drawings. Accordingly, it should be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

1. A rotating electrical machine comprising:
an electrical supply coupled to a stator;
a rotor; and
a plurality of brushes adapted for transferring electrical current from said stator to said rotor,
wherein said each particular one of said brushes is compressed between said rotor and said stator so that outward forces resulting from expansive properties of said particular brush: (A) urge at least a portion of said particular brush into contact with said rotor and said stator, and (B) maintain said at least a portion of said particular brush in contact with said rotor and said stator.

2. The rotating electrical machine of claim 1, wherein each of said brushes comprises a hollow, substantially cylindrical body formed of a conductive material, said conductive material being elastically deformable in a radial direction to provide at least a portion of said outward forces.

3. The rotating electrical machine of claim 2, wherein each particular one of said brushes further defines a recess that is substantially filled with an elastomeric material, said elastomeric material being adapted to alter a stiffness of said particular brush.

4. A rotating electrical machine comprising:
an electrical supply coupled to a stator;
a rotor; and
a plurality of brushes adapted for transferring electrical current from said stator to said rotor,
wherein each particular one of said brushes comprises:
a shaft having a first end and a second end;
a first tapered roller mounted adjacent a first end of said shaft;
a second tapered roller mounted adjacent a second end of said shaft; and
at least one biasing assembly adapted to: (A) urge at least a portion of each of said first tapered roller and said second tapered roller into contact with said rotor and said stator; and (B) maintain said at least a portion of said first tapered roller and said second tapered roller in contact with said rotor and said stator, and
wherein as said rollers travel around a periphery of said rotor and said stator, variations in gap between, said rotor and said stator are accommodated by an axial translation of said rollers relative to each other.

5. The rotating electrical machine of claim 4, wherein said first and second rollers are substantially co-axial with said shaft.

6. The rotating electrical machine of claim 4, wherein each particular one of said rollers tapers from a first end of said particular roller in a radially inward direction relative to a rotational axis of said shaft toward a second end of said particular roller.

7. The rotating electrical machine of claim 4 wherein said at least one biasing assembly comprises a spring.

8. The rotating electrical machine of claim 7 wherein said spring comprises a compression spring.

9. The rotating electrical machine of claim 4, wherein said at least one biasing assembly comprises a first compression spring and a second compression spring.

10. The rotating electrical machine of claim 9 wherein said first tapered roller defines a recessed portion adapted for receiving said first compression spring and said second tapered roller defines a recessed portion adapted for receiving said second compression spring.

11. The rotating electrical machine of claim 10 wherein said recessed portion of said first tapered roller extends from an end of said first tapered roller adjacent said first end of said shaft toward said second tapered roller and said recessed portion of said second tapered roller extends from an end of said second tapered roller adjacent said second end of said shaft toward said first tapered roller, and wherein said first compression spring is disposed between said first end of said shaft and said recessed portion of said first tapered roller and said second compression spring is disposed between said second end of said shaft and said recessed portion of said second tapered roller.

12. The rotating electrical machine of claim 4, wherein said rotor and said stator define double-tapered opposing surfaces.

13. The rotating electrical machine of claim 12, wherein an angle of taper of said tapers of said rotor and said stator is substantially similar to an angle of taper of each of said rollers.

14. The rotating electrical machine of claim 4 wherein said at least one biasing assembly comprises a first expansive spring and a second expansive spring, said first expansive spring being disposed between said first end of said shaft and said first tapered roller, and said second expansive spring being disposed between said second end of said shaft and said second tapered roller.

15. The rotating electrical machine of claim 4 wherein said at least one biasing assembly comprises an elastomeric material.

16. A rotating electrical machine comprising:
an electrical supply coupled to a stator;
a rotor; and
a plurality of brushes adapted for transferring electrical current from said stator to said rotor,
wherein each particular one of said brushes comprises:
at least two disk sections, each of said disk sections being spaced apart from each other along a central axis extending through said disk sections;
at least one flexible element disposed between two of said disk sections,
wherein said at least one flexible element is adapted for: (A) urging at least a portion of each of said disk sections into contact with said rotor and said stator, and (B) maintaining contact of said at least a portion of said disk sections with said rotor and said stator.

17. The rotating electrical machine of claim 16 wherein said central axis extends through the center of each disk section.

18. The rotating electrical machine of claim 16 wherein said at least two disk sections comprises a first disk section, a second disk section, and a third disk section, said second disk section being disposed intermediate said first disk section and said third disk section along said central axis.

19. The rotating electrical machine of claim 18 wherein a first flexible element is disposed between said first disk section and second disk section and a second flexible element is disposed between said second disk section and said third disk section.

20. The rotating electrical machine of claim 19 wherein said first and second flexible elements and said first, second, and third disk sections are disposed coaxially along said central axis.

21. The rotating electrical machine of claim 20 wherein said at least one flexible element comprises a compression spring.

22. The rotating electrical machine of claim 20 wherein said at least one flexible element comprises a helical spring member.

23. The rotating electrical machine of claim 18 wherein said rotor comprises: (1) a first track that extends in a radially outward direction toward said stator adjacent a first face of said rotor, and (2) a second track that extends in a radially outward direction toward said stator adjacent a second face of said rotor,
wherein:
said first and second tracks extend at least substantially around a circumference of said rotor,
said first track is adapted to engage said first disk section when said roller brush is in use, and
said second track is adapted to engage said third disk section when said roller brush is in use.

24. The rotating electrical machine of claim 23 wherein said stator comprises a central track that extends in a radially outward direction toward said rotor, said central track disposed between said first and second tracks of said rotor, wherein said central track is adapted to engage said second disk section when said roller brush is in use.

25. The rotating electrical machine of claim 24 wherein a diameter of said central track is selected so that said second disk section is biased slightly toward said rotor and a diameter of each of said first track and second track are selected so that said first disk section and said third disk section are biased slightly toward said stator.

26. The rotating electrical machine of claim 16 wherein said at least one flexible element comprises a compression spring.

27. The rotating electrical machine of claim 16 wherein said at least one flexible element comprises a helical spring member.

28. A method of transferring electrical current to a rotor of a rotating electrical machine, said method comprising the steps of:
providing a stator and a rotor;
providing a plurality of roller elements, said roller elements adapted for transferring electrical current from said stator to said rotor;
compressing said plurality of roller elements; and
while said plurality of roller elements are compressed, inserting said plurality of roller elements intermediate said rotor and said stator,
wherein said roller elements have a reduced radial stiffness and are biased against a surface of said stator and a surface of said rotor.

29. The method of claim 28, wherein said step of providing said roller elements comprises:
(1) providing a plurality of substantially cylindrical bodies; and
(2) compressing said substantially cylindrical bodies intermediate said stator and said rotor so that outward forces resulting from expansive properties of each particular substantially cylindrical body: (A) urge said particular substantially cylindrical body into contact with said rotor and said stator; and (B) maintain said particular substantially cylindrical body in contact with said rotor and said stator.
